(19) United States
(12) Patent Application Publication
(10) Pub. No.: US 2003/0081706 A1
(43) Pub. Date: May 1, 2003

(54) Noise reduction filtering in a wireless communication system

(76) Inventors: Steven C. Ciccarelli, Encinitas, CA (US); Arun Raghupathy, San Diego, CA (US)

Correspondence Address: QUALCOMM Incorporated, Attn: Patent Department, 5775 Morehouse Drive, San Diego, CA, 92121-1714, US

(21) Appl. No.: 10/029,052

(22) Filed: Oct. 25, 2001

(51) Int. Cl. H04B 1/10

(52) U.S. Cl. 375/350; 455/296

(57) ABSTRACT

A technique for noise reduction in a wireless communication system uses controllable bandwidth filters (120) to filter the received signal. In a typical implementation, the filters (120) are used at baseband frequencies. A measurement (RSSI) is indicative of the strength of the received signal. A control circuit (144) generates a control signal (146) to control the bandwidth of the filters (120). If the received signal strength is above a first threshold, a wider bandwidth may be used for the filters (120). If the received signal is below a second threshold, the control circuit (144) generates the control signal (146) to set the filters (120) to a more narrow bandwidth. The system (100) may also be used with digital filters (150, 152) following digitization by analog to digital converters (ADCs) (130, 132). The system (100) is particularly well-suited for operation with noise-shaped ADCs (130, 132), such as Delta-Sigma converters.

### BACKGROUND OF THE INVENTION

1. Field of the Invention

The present invention relates generally to wireless communication systems and, more particularly, to a system and method for filtering baseband signals in a wireless communication system.

2. Description of the Related Art

Wireless communication systems have increased in number and complexity in recent years. It is common that a plurality of wireless service providers may be operating in the same geographic region with overlapping areas of coverage. Because of the increased number of wireless service providers and increased usage, portions of the frequency spectrum allocated to wireless service are often utilized to their capacity or beyond.

Industry standards have been developed to minimize interference between wireless service providers and between different transmitting stations of a single wireless service provider. However, these efforts are not always successful.

For example, code division multiple access (CDMA) wireless systems have a significant capacity because multiple users can communicate on the same radio frequency (RF) channel by digitally encoding each transmission using statistically independent codes. These codes, which are sometimes referred to as orthogonal codes, uniquely encode the transmission to each wireless communication device so that a signal received by one wireless communication device is properly decoded while the same signal received by other wireless communication devices appears as noise. Thus, a CDMA system has decreased signal-to-noise ratio as more users operate on the same RF channel.

Within a particular geographical locale, multiple base transceiver systems (BTSs) operate on different RF channels so as to minimize interference with adjacent areas of coverage. In most CDMA systems, there is a guard band or portion of the frequency spectrum separating the RF channels to provide further protection against interference between BTSs. Although the RF channels may be reused, there is usually a significant geographical separation between BTSs that operate on the same RF channel so as to minimize interference.

While these precautions are useful in some wireless communication settings, other wireless communication systems do not have an adequate guard band or have no guard band at all. This architecture may permit interference to occur between BTSs that are operating on adjacent RF channels. Furthermore, some wireless communication systems may not have adequate geographical separation for frequency reuse. That is, BTSs that operate on the same RF channel have inadequate geographical separation. Again, this architecture does not provide adequate protection against interference.

Present wireless communication systems are not always capable of dealing with such interference. Therefore, it can be appreciated that there is a significant need for a system and method of filtering that enhances operation of wireless communication systems. The present invention provides this and other advantages as will be apparent from the following detailed description and accompanying figures.

### SUMMARY OF THE INVENTION

Present invention is embodied in a system and method for filtering a received radio frequency (RF) signal that has been converted to a baseband signal. In one embodiment, the inventive system comprises a control circuit that generates a control signal based on a signal strength and a filter having an input configured to receive the baseband signal and an output to generate a filtered signal. The filter further comprises a control input configured to receive the control signal and alter the filter bandwidth in response thereto. The filter has a first bandwidth if the signal strength is above a first threshold and has a second bandwidth less than the first bandwidth if the signal strength is below a second threshold. The filter may have an intermediate bandwidth if the signal strength is between the first and second thresholds.

In one embodiment, the first and second thresholds may be identical. The control circuit may generate the control signal based on the signal strength of the baseband signal.

In one embodiment, the filter has a continuously variable bandwidth and the control signal is a continuously variable control signal over a pre-determined signal range to control the filter bandwidth. In one embodiment, the filter is an analog filter. Alternatively, the system further comprises an analog-to-digital converter that converts the baseband signal to a digital baseband signal. The filter may be implemented as a digital filter to filter the digital baseband signal. The system may be implemented in a quadrature RF receiver. In this embodiment, the filter comprises first and second filter portions to filter quadrature signal components.

### BRIEF DESCRIPTION OF THE DRAWINGS

FIG. 1 is a functional block diagram of one implementation of the present invention.

FIGS. 2A-2C are sample frequency spectra illustrated in the operation of the system of the present invention.

FIG. 3 is a functional block diagram illustrating another implementation of the present invention.

FIGS. 4A and 4B are sample frequency spectra illustrating the operation of the system with a noise-shaped analog-to-digital converter.

### DETAILED DESCRIPTION OF THE PREFERRED EMBODIMENTS

The present invention is directed to a technique for filtering baseband signals and thereby improve the reliability of wireless communications. The system of the present invention measures signal strength of a received signal. When the received signal is at a low signal level, the bandwidth of a filter system may be reduced. The reduction in the bandwidth reduces the noise bandwidth and increases the rejection of adjacent channels. In contrast, when the received signal strength is above a predetermined threshold, the system may provide a wider bandwidth to take advantage of the greater signal strength.

Wireless communication devices have a radio frequency (RF) stage that tunes the device to a selected RF channel. Those skilled in the art can appreciate that the term RF channel refers to a portion of the frequency spectrum. In accordance with industry standards, the portion of the spectrum allocated for wireless communication devices may be apportioned into a plurality of RF channels, each having a bandwidth designated by the industry standard.

Many wireless communication devices also utilize an intermediate frequency (IF) stage. The radio frequency signal detected by the RF stage is mixed or translated down to the intermediate frequency. The IF stage may perform additional amplification and/or filtering. However, a new trend in wireless communication devices, particularly in a CDMA wireless communication device, is to mix the output of the RF stage directly to baseband frequencies. The implementations illustrated herein are directed to a CDMA system that uses direct-to-baseband architecture. However, those skilled in the art will recognize that the principles of the present invention are applicable to wireless communication architectures other than a CDMA system and to wireless communication architectures that do not utilize direct-to-baseband conversion.

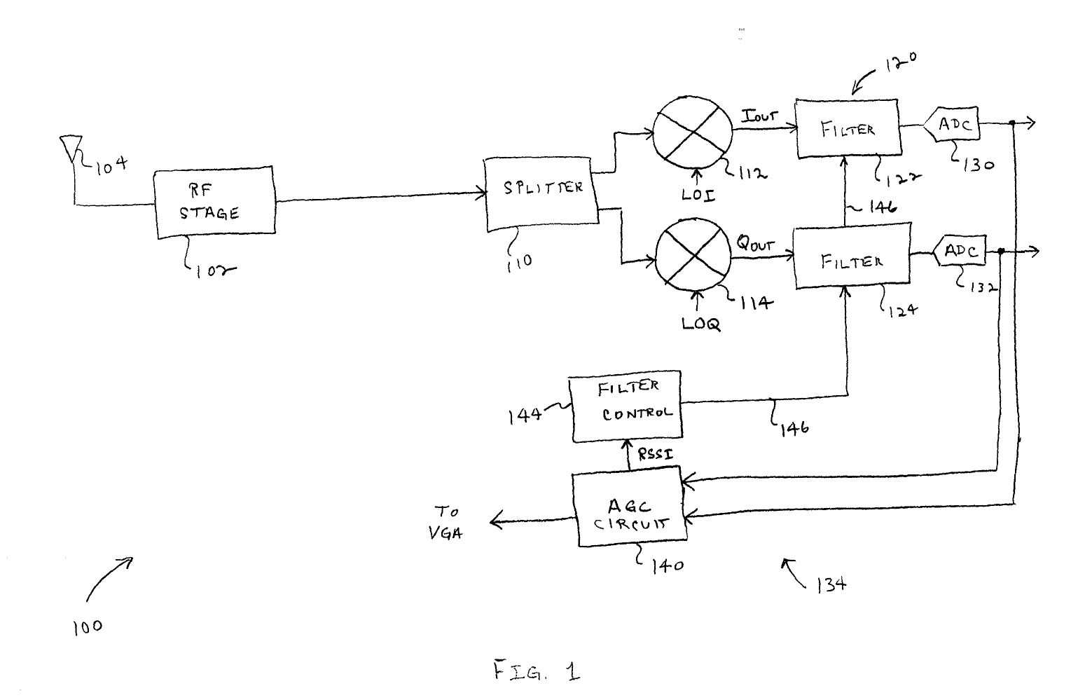

The present invention is embodied in a system 100 illustrated in the functional block diagram of FIG. 1. The system 100 includes a conventional RF stage 102, which is coupled to an antenna 104. The operation of the RF stage 102 and antenna 104 are known in the art and need not be described in detail herein. The RF stage 102 includes a tuner that may be tuned to the selected RF channel. In addition to the tuner, the RF stage 102 may include amplifiers and/or filters. The output of the RF stage is a modulated RF signal on the selected RF channel.

The output of the RF stage 102 is coupled to a splitter 110, which splits the RF signal into two identical signals for subsequent quadrature demodulation. The two identical outputs from the splitter 110 are coupled to identical down-mixers 112 and 114. A conventional down-mixer receives a radio frequency signal and a local oscillator signal as inputs and generates outputs at the sum and difference frequencies of the two input signals. The down-mixers 112 and 114 are identical in operation except for the phase of the local oscillator. The local oscillator provided to the down-mixer 112 is designated as a local oscillator LOI, while the local oscillator provided to the down-mixer 114 is designated as a local oscillator LOQ. The local oscillators LOI and LOQ have identical frequency but have a phase offset of 90° with respect to each other. Therefore, the output of the down-mixers 112 and 114 are quadrature outputs designated as I_{OUT} and Q_{OUT}, respectively. As noted above, the system illustrated in the functional block diagram of FIG. 1 uses a direct-to-baseband architecture. Accordingly, the local oscillators LOI and LOQ are selected to mix the RF signal directly down to baseband frequency.

The outputs from the down-mixers 112 and 114 are coupled to a filter stage 120, which comprises filters 122 and 124. In a conventional CDMA system, the filters 122 and 124 may simply be low-pass filters having a fixed bandwidth. However, in the implementation of the system 100, the filters 122 and 124 are variable bandwidth filters. As will be described in greater detail below, the bandwidth of the filters 122 and 124 is altered based on the strength of the received signal. The output of the filters 122 and 124 are coupled to analog-to-digital converters 130 and 132, respectively The filters 122 and 124 may function as anti-aliasing filters in addition to the variable bandwidth filter function of the present invention.

The ADCs 130 and 132 convert the received signals to digital form for subsequent processing. The operation of the ADCs 130 and 132 are known in the art and need not be described in any greater detail herein. Although any type of ADC may be used to implement the ADCs 130 and 132, the system 100 is ideally suited for operation with high dynamic range noise-shaped ADCs, such as a Delta-Sigma ADC, or other noise-shaped ADCs. The present invention is not limited by the specific form of the ADCs. Additional signal processing occurs following conversion of the baseband signals to digital form. However, the subsequent process of decoding quadrature signals is known in the art and need not be described herein since it forms no part of the present invention.

The output of the ADCs 130 and 132 are also used as part of an automatic gain control loop (AGC) 134. The AGC loop 134 generates a control signal that controls the gain of the signals provided to the ADCs 130 and 132. The AGC loop 134 advantageously maximizes the voltage presented at the inputs to the ADCs 130 and 132 to thereby improve the conversion processing of the ADCs.

The output of the ADCs 130 and 132 are coupled to inputs of an AGC circuit 140. The AGC circuit 140 contains a number of components that are well known in the art and need not be described herein. For example, the AGC circuit may include a logarithmic converter so that the gain of the signal from the RF stage 102 is controlled in decibels (dB). The AGC circuit 140 may also include an integrator to control the loop response time and may also include a linearizer to provide correction factors for non-linear responses of gain controls. The linearizer provides correction factors so as to linearize the control voltage of a variable gain amplifier (VGA) (not shown). The VGA may be a standalone device inserted, by way of example, between the RF stage 102 and the splitter 110. Alternatively, the VGA may be an integral part of the RF stage 102. The variable gain may be continuously adjustable or may be provided as gain steps. This specific implementation of any VGA would be known to one of ordinary skill in the art and need not be described in greater detail herein. Other components, known in the art, may also be part of the AGC circuit 140. For the sake of brevity, those various components are simply illustrated in FIG. 1 as the AGC circuit 140.

The AGC circuit 140 also provides a measure of the received signal strength. In wireless communication systems, this level is sometimes referred to as a received signal strength indicator (RSSI). In addition to control of the VGA (not shown), the RSSI from the AGC circuit 140 is provided to a filter control 144. The filter control 144 uses the RSSI to control the bandwidth of the filters 122 and 124. The filter control 144 generates a filter control signal 146 that is coupled to filter control inputs on the filters 122 and 124 to control the bandwidth of the filters. The filter control signal 146 may take a variety of forms. For example, the filter control signal may be a serial bus interface (SBI) data word or simply an analog control voltage. The implementation details of the filter control signal 146 may be carried out by one skilled in the art based on the teachings contained herein.

In an exemplary embodiment, the filter control 144 generates the filter control signal 146 to maintain a normal bandwidth for the filters 122 and 124 when the RSSI is above a first predetermined threshold. That is, the bandwidth of the filters 120 and 124 matches the bandwidth of a filter in a conventional CDMA system. In the presence of a relatively strong received signal, it is desirable to maximize the bandwidth of the signal from the filters 122 and 124 to the inputs of ADCs 130 and 132, respectively.

In contrast, when the received signal is very low, it may be desirable to reduce the bandwidth of the filters 122 and 124. In an exemplary embodiment, if the RSSI is below a second predetermined threshold, the filter control signal 146 generated by the filter control 144 sets the filters 122 and 124 to a second more narrow bandwidth. The reduction in bandwidth effectively reduces the noise bandwidth. The reduced bandwidth also effectively improves adjacent channel rejection.

An intermediate bandwidth may be used for the filters 122 and 124 if the received signal strength (e.g., RSSI) is above the second threshold, but below the first threshold. As will be described in greater detail below, the intermediate bandwidth setting is selected as an optimization of system noise and distortion. In an alternative embodiment, the filters 122 and 124 may have a continuously variable bandwidth that decreases as the received signal strength (e.g., RSSI) decreases.

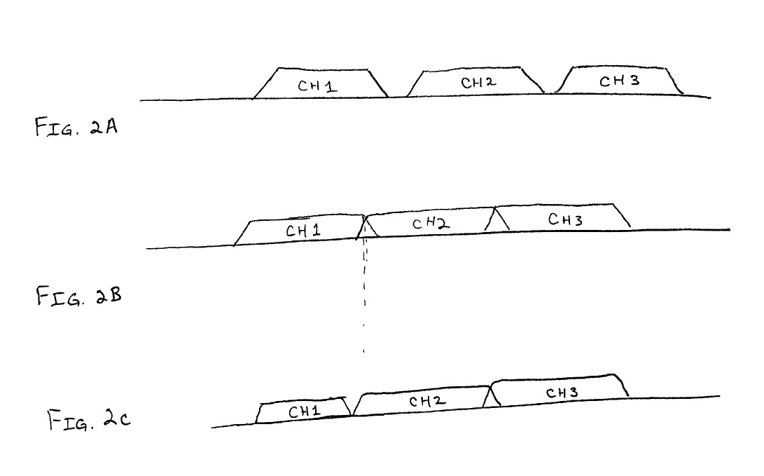

The reduced bandwidth is particularly important in a wireless communication architecture in which no guard band or inadequate guard bands have been provided. This concept is illustrated in the sample spectra of FIGS. 2A-2C. In FIG. 2A, a normal bandwidth with adequate guard band separation between adjacent channels is illustrated. The guard band separation allows the signals from one channel to roll off without interfering with the adjacent channel.

FIG. 2B illustrates a spectrum in which no guard bands are provided. As can be seen from FIG. 2B, the overlap between adjacent channels CH1 and CH2 is apparent. Similar overlap occurs between adjacent channels CH2 and CH3. As those skilled in the art will appreciate, such overlap will cause interference. In a CDMA system, that interference appears as decreased signal-to-noise ratio.

FIG. 2C illustrates the operation of the present invention on, by way of example, channel CH1. As is apparent from FIG. 2C, the reduced bandwidth of channel CH1 avoids the portion of the spectrum where channel CH2 would otherwise overlap and interfere with CHI. The result is an increase in adjacent channel rejection.

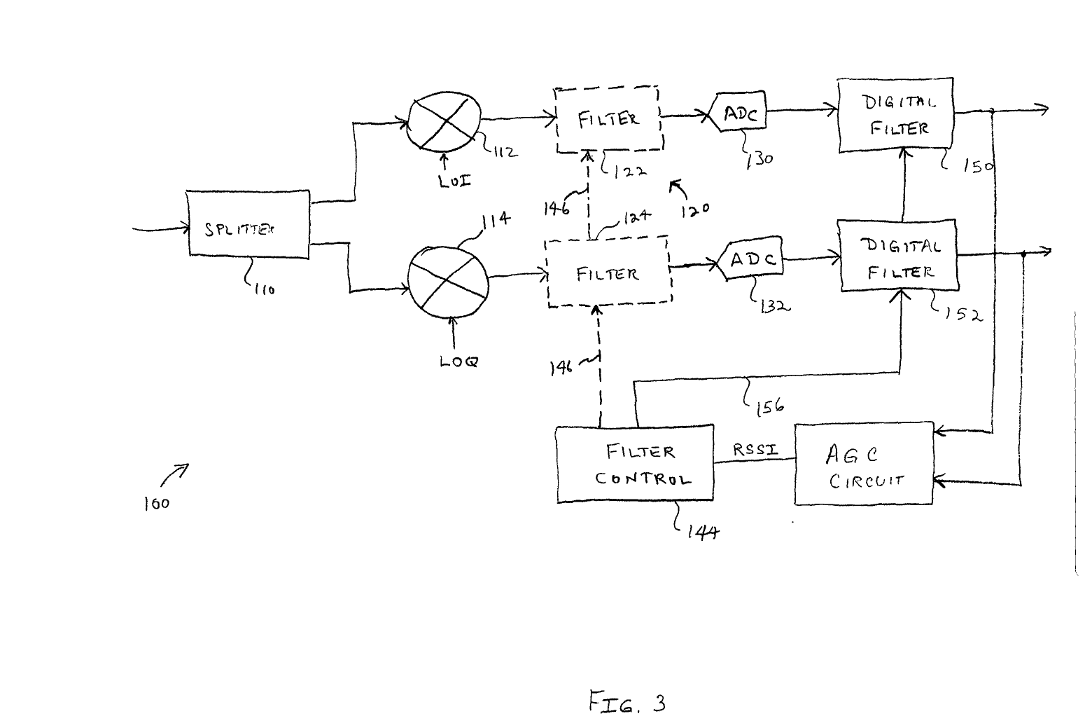

The embodiment of FIG. 1 illustrates an analog implementation for the filter stage 120. However, the system 100 may also be implemented using digital filtering techniques or a combination of analog and digital filtering techniques. This is illustrated in the embodiment of FIG. 3. As illustrated in FIG. 3, the output of the ADC 130 and the ADC 132 are coupled to the input of digital filters 150 and 152, respectively. The digital filters 150 and 152 operate in a manner similar to that described above with respect to the filters 120 and 122. That is, the digital filters 150 and 152 are set to a normal bandwidth when the received signal strength is above the pre-determined threshold.

When the received signal is below the pre-determined threshold, the filter control 144 generates a filter control signal 156 to reduce the bandwidth of the digital filters 150 and 152 and the filter control 154. As those skilled in the art can appreciate, the digital filters 150 and 152 may be implemented as part of a digital signal processor (DSP) (not shown) or a central processing unit (CPU) (not shown). However, these elements are illustrated in the functional block diagram of FIG. 3 as separate components since each performs a separate process.

The filter control signal 156 is illustrated in the functional block diagram of FIG. 3 as a single control line. However, the digital filters 150 and 152 may be implemented by providing new filter coefficients to alter the bandwidth of the digital filters 150 and 152. Thus, the filter control signal 156 may actually comprise coefficients for the digital filters in order to accomplish the desired reprogramming.

In addition to the digital filters 150 and 152, the system 100 illustrated in the functional block diagram of FIG. 3 may also include the analog filters 122 and 124. The filters 122 and 124 are illustrated in FIG. 3 in dashed form to indicate that they are optional. However, the combination of the analog filters 122 and 124 and the digital filters 150 and 152 provide additional filtering that may be desirable in certain implementations. The filter control signal 146 may be implemented in analog or digital form, as described above. Whether the system 100 is implemented using the analog filters 122 and 124, the digital filters 150 and 152, or a combination of analog and digital filters, the selective alteration of the channel bandwidth based on the received signal strength advantageously improves the response of the system 100.

The system 100 reduces the bandwidth of the filters (either the analog filter stage 120 or the digital filters 150 and 152) based on the received signal level. In one implementation, the bandwidth of the filters is reduced when the signal received by the RF stage 102 (See FIG. 1) is at sensitivity. The term “at sensitivity,” refers to the lowest discernible signal that may be processed by the wireless communication device. The determination of a receiver at sensitivity is known in the art and need not be described in detail herein.

When the system 100 is at sensitivity, the dominating noise sources are thermal noise and quantization noise from the ADCs 130 and 132.

When the system 100 is at sensitivity, it is operating below the second predetermined threshold. In this low power regime, the bandwidth of the filters (i.e., the filter stage 120 and/or the digital filters 150-152) is reduced to attenuate noise out of the ADCs 130 and 132.

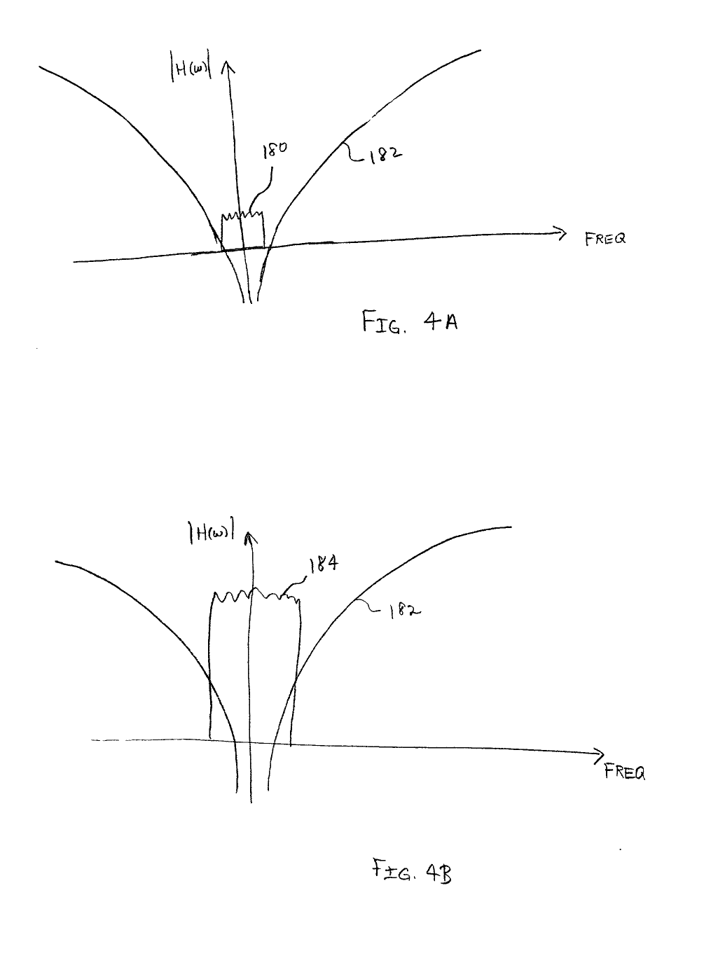

As previously noted, the ADCs 130 and 132 may be a Delta-Sigma type, or other, which shapes the noise such that the noise rapidly increases out-of-band. This concept is illustrated in the transfer of function of FIG. 4A where a low power CDMA spectrum 180 is plotted against a quantization noise spectrum of a noise-shaped ADC. Although FIG. 4A illustrates the quantization noise spectrum of a Delta-Sigma type converter, those skilled in the art will recognize the system 100 may operate with other types of ADCs whether they are noise-shaped or not. However, the system 100 is ideally suited for operation with a noise-shaped ADC.

If a normal CDMA bandwidth were maintained, the CDMA spectrum 180 would include a significant amount of quantization noise. However, a reduction in the bandwidth produces the CDMA spectrum 180. As illustrated in FIG. 4A, the reduced bandwidth of the CDMA spectrum 180 results in a significant decrease in the quantization noise included within the CDMA bandwidth thus resulting in a significant improvement in the overall system response. Although the reduction in bandwidth leads to increased distortion in the form of inter-chip interference (ICI), the increase in ICI is negligible until the input power is much higher.

Use of two predetermined thresholds (i.e., the first and second thresholds) allows three regimes of operation. The low power regime has been discussed above. Filtering for the high power regime (i.e., the received signal is above the first predetermined threshold), filtering is optimal when ICI=0. That is, the bandwidth of the filters (i.e., the filter stage 120 and/or the digital filters 150-152) are adjusted to achieve zero or near-zero ICI. In the case of analog filters (i.e., the filters 122 and 124), the bandwidth may be wider to eliminate droop. The digital filters 150-152 may be reprogrammed with new filter coefficients to achieve zero ICI. Altering the filter coefficients may result in an altered bandwidth, but may also equalize the phase and amplitude responses of the digital filters 150-152 to achieve zero or near-zero ICI.

Allowing additional noise through the filters as a result of the wider bandwidth is not a problem since the integrated noise is still well below the signal level. This is illustrated in the transfer function of FIG. 4B where a response CDMA spectrum 184 of the system 100 is plotted against the noise spectrum 182. Although the example illustrated in FIG. 4B includes a greater degree of quantization noise from the ADCs 130 and 132 (see FIGS. 1 and 3), the additional noise is negligible when compared to the power of the CDMA spectrum 184.

The third power regime occurs when the received signal strength is below the first predetermined threshold (i.e., the high threshold) and above the second predetermined threshold (i.e., the low threshold). In this middle regime, a compromise between the noise bandwidth and the ICI must be made.

The bandwidth of the filters are selected for optimal operation. The analog filters 122-124 may be tuned to the desired bandwidth while the filter coefficients may be transmitted to the digital filters 150-152 to select a desired intermediate bandwidth.

In a simplified implementation of the system 100, the first and second predetermined thresholds may be identical (i.e., only a single threshold is used). In this embodiment, the system 100 includes only a low power regime, in which the filters have a narrow or reduced bandwidth and a high power regime, in which the filters have a wide or normal bandwidth and ICI equals zero or is at a minimal level. The intermediate power regime, with intermediate bandwidth filters, is eliminated in this simplified embodiment.

Since the input power is known, it is possible to narrow the filter bandwidth at sensitivity and to increase the filter bandwidth for high input power levels. The system 100 generates filter control signals (i.e., the filter control signal 146 and/or the filter control signal 156) to adjust the bandwidth of the corresponding filter for high input power levels. Thus, overall system performance is enhanced by the additional filtering process.

It is to be understood that even though various embodiments and advantages of the present invention have been set forth in the foregoing description, the above disclosure is illustrative only, and changes may be made in detail, yet remain within the broad principles of the invention. Therefore, the present invention is to be limited by the appended claims.

What is claimed is:

1. A system for baseband filtering in a wireless communication system, comprising:
a radio frequency (RF) receiver to detect signals transmitted by a remote device;
a mixer to convert the detected signal from the RF receiver to baseband frequency and thereby generate a baseband signal;
a variable bandwidth filter having an input and an output and a control input, the filter filtering the baseband signal and thereby generating a filtered signal;
a signal strength detector to determined a signal strength of the detected signal; and
a filter control circuit to generate a control signal based on the signal strength, the control signal being coupled to the control input and causing the filter to have a first bandwidth if the signal strength is above a first threshold and to have a second bandwidth less than the first bandwidth if the signal strength is below a second threshold.

2. The system of claim 1 wherein the filter is an analog filter coupled to the output of the mixer.

3. The system of claim 1, further comprising an analog-to-digital converter (ADC) to convert the baseband signal to a digital baseband signal, the filter being a digital filter to filter the digital baseband signal.

4. The system of claim 3 wherein the control signal from the control circuit alters filter coefficients of the digital filter to alter the amplitude or phase characteristics of the digital filter.

5. The system of claim 1 wherein the first and second thresholds are identical.

6. The system of claim 1 wherein the filter has a first bandwidth setting and a second bandwidth setting, the first bandwidth setting being selected when the signal strength is above the first threshold and the second bandwidth setting being selected when the signal strength is below the second threshold.

7. The system of claim 1 wherein the filter has an intermediate bandwidth setting with a filter bandwidth less than the first bandwidth and greater than the second bandwidth, the intermediate bandwidth setting being selected when the signal strength is below the first threshold and above the second threshold.

8. The system of claim 1 wherein the filter has a continuously variable bandwidth and the control signal is a continuously variable control signal over a predetermined signal range to control the filter bandwidth.

9. The system of claim 1 for use in a quadrature RF receiver wherein the variable bandwidth filter comprises first and second filter portions to filter quadrature signal components.

10. The system of claim 1 for use in a quadrature RF receiver wherein the mixer comprises first and second mixer components to convert the detected signal to first and second quadrature baseband signals, each of the quadrature baseband signals being coupled to an input on an analog-to-digital converter (ADC) to convert the quadrature baseband signals to digital signals, the filter being a digital filter that filters the digitized baseband signals.

11. The system of claim 1 wherein RF receiver is at sensitivity, the filter control circuit selecting causing the filter to have the second bandwidth when the signal strength is at sensitivity.

12. A system for baseband filtering of a received radio frequency (RF) signal that is converted to a baseband signal, comprising:
a control circuit to generate a control signal based on signal strength of the received signal; and
a filter having an input configured to receive the baseband signal and an output to generate a filtered signal, the filter further comprising a control input configured to receive the control signal and alter the filter bandwidth in response thereto, the filter having a first bandwidth if the signal strength is above a first threshold and having a second bandwidth less than the first bandwidth if the signal strength is below a second threshold.

13. The system of claim 12 wherein the first and second thresholds are identical.

14. The system of claim 12 wherein the control circuit generates the control signal based on the signal strength of the baseband signal.

15. The system of claim 12 wherein the filter has a continuously variable bandwidth and the control signal is a continuously variable control signal over a predetermined signal range to control the filter bandwidth.

16. The system of claim 12 wherein the filter is an analog filter.

17. The system of claim 12, further comprising an analog-to-digital converter (ADC) to convert the baseband signal to a digital baseband signal, the filter being a digital filter to filter the digital baseband signal.

18. The system of claim 17 wherein the control signal from the control circuit alters filter coefficients of the digital filter to alter the amplitude or phase characteristics of the digital filter.

19. The system of claim 12 for use in a quadrature RF receiver wherein the filter comprises first and second filter portions to filter quadrature signal components.

20. An apparatus for baseband filtering of a received radio frequency (RF) signal that is converted to a baseband signal, comprising:
filter means for receiving the baseband signal and generating a filtered signal, the filter means having a control input; and
control means coupled to the control input to control filter bandwidth based on signal strength wherein the filter means have a first bandwidth if the signal strength is above a first threshold and a second bandwidth less than the first bandwidth if the signal strength is below a second threshold.

21. The system of claim 20 wherein the first and second thresholds are identical.

22. The system of claim 20 wherein the control means controls filter bandwidth based on the signal strength of the baseband signal.

23. The system of claim 20 wherein the filter means have a continuously variable bandwidth and the control means generate a continuously variable control signal over a predetermined signal range to control the filter bandwidth.

24. The system of claim 20 wherein the filter means are an analog filter.

25. The system of claim 20, further comprising conversion means for converting the baseband signal from an analog signal to a digital baseband signal, the filter means being a digital filter to filter the digital baseband signal.

26. The system of claim 25 wherein the control means alters filter coefficients of the digital filter means to thereby alter the amplitude or phase response of the digital filter means.

27. The system of claim 20 for use in a quadrature RF receiver wherein the filter means comprise first and second filter portions to filter quadrature signal components.

28. A system for baseband filtering of a received radio frequency (RF) signal that is converted to a baseband signal, comprising:
a noise-shaped analog to digital converter (ADC) to convert the baseband signal to a digital baseband signal;
a filter having an input and an output and a control input to control a bandwidth of the filter; and
a control circuit coupled to the control input to control the filter bandwidth based on signal strength of the received RF signal.

29. The system of claim 28 wherein the ADC is a Delta-Sigma ADC.

30. The system of claim 28 wherein the filter has a first bandwidth if the signal strength is above a first threshold and has a second bandwidth less than the first bandwidth if the signal strength is below a second threshold.

31. The system of claim 30 wherein the filter has an intermediate bandwidth setting with a filter bandwidth less than the first bandwidth and greater than the second bandwidth, the intermediate bandwidth setting being selected when the signal strength is below the first threshold and above the second threshold.

32. The system of claim 30 wherein the first and second thresholds are identical.

33. The system of claim 30 wherein the first bandwidth is selected to reduce inter-chip interference to approximately zero.

34. The system of claim 28 wherein the filter is an analog filter and the filter output is coupled to the ADC.

35. The system of claim 28 wherein the filter is a digital filter and the filter input is coupled to the ADC.

36. The system of claim 35 wherein the control signal further alters filter coefficients of the digital filter to alter the amplitude or phase response of the digital filter.

37. The system of claim 28 wherein the filter bandwidth is selected to reduce noise bandwidth of the ADC based on the received signal strength.

38. An apparatus for baseband filtering of a received radio frequency (RF) signal that is converted to a baseband signal, comprising:
a filter to receive the baseband signal and generate a filtered signal, the filter having a control input; and
a control circuit coupled to the control input to control filter bandwidth based on signal strength wherein the filter has a first bandwidth if the signal strength is above a first threshold and a second bandwidth less than the first bandwidth if the signal strength is below a second threshold.

39. An apparatus for baseband filtering of a received radio frequency (RF) signal that is converted to a baseband signal, comprising:
a noise-shaped analog to digital converter (ADC) to convert the baseband signal to a digital baseband signal;
a filter having a control input to control a bandwidth of the filter; and
a control circuit coupled to the control input to control the filter bandwidth based on signal strength of the received RF signal.

40. A method for noise reduction of a received radio frequency (RF) signal that is converted to a baseband signal, comprising:
generating a signal indicative of a signal strength; and
filtering the baseband signal using a first bandwidth if the signal strength is above a first threshold and using a second bandwidth less than the first bandwidth if the signal strength is below a second threshold.

41. The method of claim 40 wherein the first and second thresholds are identical.

42. The method of claim 40 wherein filtering further comprises filtering the baseband signal using an intermediate bandwidth less than the first bandwidth and greater than the second bandwidth if the signal strength is below the first threshold and above the second threshold.

43. The method of claim 40 wherein the received radio signal is received by a receiver at sensitivity, the filter using the second bandwidth when the signal strength is at sensitivity.

44. The method of claim 40 wherein the filter bandwidth is based on the signal strength of the baseband signal.

45. The method of claim 40 wherein the filtering uses a continuously variable bandwidth.

46. The method of claim 40 wherein the filtering is performed by an analog filter.

47. The method of claim 40, further comprising converting the baseband signal to a digital baseband signal, the filtering being digital filtering of the digital baseband signal.

48. The method of claim 47, further comprising altering filter coefficients of the digital filter to alter the amplitude or phase response of the digital filter.

49. The method of claim 48 for use in a quadrature RF receiver wherein the filtering comprises filtering quadrature signal components.
